(19) United States
(12) Patent Application Publication
(10) Pub. No.: US 2023/0025537 A1
(43) Pub. Date: Jan. 26, 2023

(54) MIXTURE COMPRISING HYDROGENATED SOYBEAN OIL AND THYMOL

(71) Applicant: DSM IP Assets B.V., HEERLEN (NL)

(72) Inventors: Ivan de Jesus GAYTAN PEREZ, Kaiseraugst (CH); Hong LIU, Kaiseraugst (CH)

(21) Appl. No.: 17/783,460

(22) PCT Filed: Dec. 8, 2020
(86) PCT No.: PCT/EP2020/085038

§ 371 Date: Jun. 8, 2022

(30) Foreign Application Priority Data
Dec. 9, 2019 (CN) PCT/CN2019/123986

(51) Int. Cl. A23K 20/158; A23K 20/111; A23K 10/30; A23K 40/10

(52) U.S. Cl. CPC A23K 20/158; A23K 20/111; A23K 10/30; A23K 40/10

(57) ABSTRACT

The present invention relates to use of preferably fully hydrogenated soybean oil for manufacturing a particulate feed additive that is resistant to heat induced caking The mixture of the invention comprises hydrogenated soybean oil and thymol, wherein the weight ratio between hydrogenated soybean oil and thymol is from 10:1 to 1:1 and/or wherein the mixture comprises 5-30 weight-% of thymol, based on the total weight of the mixture. Preferably, the mixture is shaped as particles by spray chilling. The particles are then used as a feed additive. The feed additive may be a premix.

### TECHNICAL FIELD

The present invention relates to the transportability of particulate feed additives having microbial modulation activity.

### BACKGROUND OF THE INVENTION

Terpenes are widespread in nature. The use and manufacturing of terpene-containing compositions is disclosed in WO 2007/063267.

At room temperature, most terpenes are liquid. One of the few exceptions is thymol. Thymol is a white crystalline substance with a melting point ranging from 49° C. to 51° C. Therefore, thymol crystals as such could be added to a premix of vitamins, minerals and other additives. Unfortunately, thymol as such has an unpleasant taste and smell which makes it less palatable (Nieddu M. et al. Improvement of thymol properties by complexation with cyclodextrins: In vitro and in vivo studies. Carbohyd. Polym. 2014; 102 393-399).

Robbins encapsulated thymol in gelatine capsules before administering it to dogs (Robbins B. H. Quantitative studies on the absorption and excretion of certain resorcinols and cresols in dogs and man. J. Pharmacol. Exp. Therapeut. 1934; 52 54-60). Whereas such an approach reduces the smell and taste of thymol, it is not possible to add gelatine capsules to feed premixes. Gelatine capsules are by far too expensive for the use in the feed industry. Furthermore, a premix containing two-piece gelatine capsules would easily de-mix, i.e. would have a very poor blend uniformity.

For centuries, thymol has been used in traditional medicine. It has been shown to possess various pharmacological properties including antioxidant, free radical scavenging, anti-inflammatory, analgesic, antispasmodic, antibacterial, antifungal, antiseptic and antitumor activities (Meeran et al. Pharmacological Properties and Molecular Mechanisms of Thymol: Prospects for Its Therapeutic Potential and Pharmaceutical Development. Front Pharmacol. 2017; 8: 380).

There is a need for a cost-effective manner to reduce smell and/or taste of thymol. The sought-after formulation of thymol should be a powder with reduced smell, should be suitable for providing premixes with high blend uniformity, should be easy to manufacture at low cost, should be environmentally friendly, must be non-toxic and must fulfill the applicable regulatory requirements.

Most importantly, however, the sought-after formulation must have excellent transportability: large quantities of the formulation (e.g. hundreds of kilos or even tons) must be movable in summer with trucks, railways, ships etc. without any negative impact on the quality of the product. In particular, heat induced caking during transportation of the formulation in a closed truck without air-conditioning is to be avoided or at least reduced.

### SUMMARY OF THE INVENTION

The present invention relates to the use of hydrogenated soybean oil for manufacturing a particulate feed additive that is resistant to heat induced caking. The preferred hydrogenated soybean oil of the invention is fully hydrogenated soybean oil.

Surprisingly, the melting point of a mixture comprising hydrogenated soybean oil and thymol is as high or even higher than the melting point of hydrogenated soybean oil as such. Also surprisingly, not even the addition of a liquid terpene lowers the melting point to a degree such that caking occurs during transportation in summer due to the impact of heat.

The problems underlying the present invention are solved by a mixture comprising hydrogenated soybean oil and thymol. Preferably, the mixture of the invention comprises hydrogenated soybean oil and thymol in a weight ratio between hydrogenated soybean oil and thymol is from 10:1 to 1:1, and/or wherein the mixture comprises 5-30 weight-% of thymol, based on the total weight of the mixture.

The mixture of the invention is preferably used for preparing feed or for preparing a premix that can be added to feed. For this use, the mixture of the invention is preferably shaped as particles. The powder of the invention comprises or consists of the particles of the invention. The powder of the invention may be a feed additive such as a premix.

The present invention also relates to a method of manufacturing particles comprising hydrogenated soybean oil and thymol, said method comprising the steps:
i. providing the mixture of the invention, wherein the mixture has a temperature of at least 65° C.;
ii. cooling the mixture provided in step i) by spraying said mixture into a cooling medium.

The preferred method of manufacturing the particles of the invention is spray chilling, also known as prilling. Therefore, the present invention also relates to the use of hydrogenated soybean oil for spray chilling.

The particles of the invention are storage stable, smell less because thymol is encased in a matrix of hydrogenated soybean oil and are environmentally friendly as there is no need for devastating palm oil production.

The particles of the invention have excellent transportability because they are resistant to heat induced caking. Temperatures which typically occur during transportation (e.g. in a closed truck or wagon train) do not induce caking: the particles do not melt together, i.e. no lumps are formed. The particles of the invention are edible and have antimicrobial activity. In case they comprise both, thymol and eugenol, the particles of the invention can be used in the treatment of gastrointestinal disorders caused by Escherichia coli.

### DETAILED DESCRIPTION OF THE INVENTION

Enteric diseases due to bacterial species are a major health problem of swine, poultry and other animals. Escherichia coli and Salmonella choleraesuis are the major bacterial causes of diarrhea in post-weaning pigs.This is likely to compromise gut functionality and growth performance. Clostridium perfringens infection in poultry leads to damage to the mucosal tissue and therefore decreases growth performance. These bacteria also constitute a risk for transmission from animals to humans through the food chain. The traditional way to prevent or control these problems is to include antibiotics in the feed. The restriction on the use of antibiotics as feed additives has impeded nutritionists and feed producers to develop alternatives to antibiotics.

Thymol has growth-promoting and antimicrobial properties and is therefore an alternative to antibiotics. Most likely, the primary mechanism of against pathogenic organisms is the lipophilic property and lyophobic component of thymol, which compromises the bacterial cell membrane integrity by increasing the membrane permeability and leakage of intracellular constituents.

Whereas thymol is a promising candidate for developing a potent antimicrobial agent for application in the livestock industry, thymol has a significant drawback: it is volatile and has a strong unpleasant smell. Known techniques for formulation of volatile compounds include spray coating, extrusion, coacervation and spray chilling. According to the present invention, spray chilling is preferred as it is a very cost-effective method. In the feed industry, cost control is of utmost importance.

When hot, melted hydrogenated oil is sprayed into a cooling medium (e.g. air), particles consisting of hydrogenated oil are obtained. Powders consisting of such particles are flowable. However, when such powder is exposed to heat (e.g. 40° C-55° C., depending on the chosen hydrogenated oil), the particles become soft and eventually start melting. As a result, the particles melt together, i.e. lumps are formed. This is referred to as heat induced caking. The formation of agglomerates due to increased temperature is to be prevented because it impacts the flowability of the powder and therefore its transportability. In addition, it also affects the capacity of the powder to be dosed and mixed properly.

Typically, heat induced caking becomes more severe when an additional compound is added. Similar to freezing-point depression, the melting point of hydrogenated oil is typically decreased on the addition of an additional compound, probably due to steric hindrance.

Surprisingly, the melting point of hydrogenated soybean oil remains substantially unchanged when thymol is added. The melting point of hydrogenated soybean oil even remains unchanged when an oily, liquid terpene is added.

Definitions

Hydrogenation turns liquid oils into solid fat. In the context of the present invention, the term “hydrogenated soybean oil” refers to a compound that is solid at room temperature. In the context of the present invention, room temperature refers to 25° C. Partially hydrogenated oils are semi-soft solids and still contain some unsaturated fatty acids. The hydrogenated soybean oil of the invention is preferably fully hydrogenated soybean oil. In a less preferred embodiment, the hydrogenated soybean oil of the invention is partially hydrogenated soybean oil.

The “mixture” of the invention is typically a dispersion, a suspension, a solid solution, a liquid solution, an emulsion or a combination thereof.

The particles of the invention comprise hydrogenated soybean oil. In the context of the present invention, “resistant to heat induced caking” means that the particles do not form lumps due to melting unless a specified temperature is reached. During transportation, the particles of the invention might stick together, but they do not melt together at a temperature lower than the specified temperature—and because they are not melted together, they can easily be separated from each other. In contrast, a lump formed due to melting is one single particle that cannot be easily broken. The specified temperature is preferably 52° C., i.e. the particles of the invention do not melt together as long as the temperature is less than 52° C. In other embodiments of the invention, the specified temperature is preferably 50° C., 51° C., 53° C., 54° C., 55° C., 56° C., 57° C., 58° C., 59° C. or 60° C. In yet another embodiment of the invention, the specified temperature is the melting temperature of 2^{nd} endothermic peak of fully hydrogenated soybean oil.

In the context of the present invention, the term “terpene” is used in a broad manner and includes modified terpenes such terpenoids and isoterpenoids. Examples of terpenes are cinnamaldehyde, carvacrol, linalool, limonene and anethol. In the context of the present invention, eugenol is considered as a terpene. Terpenes that are liquid at room temperature are referred to as liquid terpenes. Eugenol is the preferred liquid terpene.

A feed additive is an edible supplement used in animal nutrition for purposes of improving the quality of feed. If a feed additive is shaped as particles, it is a “particulate feed additive”.

In the context of the present invention, a “premix” is a feed additive that comprises more than one active ingredient. The main objective of premixes is to deliver vitamins, trace minerals, active ingredients, feed supplements and alike in a manner desired by customer. Premixes are used to facilitate uniform dispersion of micro-ingredients in a larger mix. The mixture or particles of the invention may be added to a premix. Premixes comprising the particles of the invention hardly de-mix, i.e. they have a good blend uniformity. The premix of the invention is preferably a powder comprising different kinds of particles.

Mixture of the Invention

The present invention relates to a mixture comprising hydrogenated soybean oil, thymol and optionally at least one terpene is preferably liquid at room temperature. Preferably, the mixture comprises fully hydrogenated soybean oil.

In one embodiment, the mixture of the invention comprises fully hydrogenated soybean oil and thymol, wherein the weight ratio between fully hydrogenated soybean oil and thymol is from 10:1 to 1:1, preferably from 8:1 to 2:1, more preferably from 7:1 to 3:1 and most preferably from 6:1 to 5:1. In another embodiment, the mixture of the invention comprises fully hydrogenated soybean oil and thymol, wherein the mixture comprises 5-30 weight-% of thymol, preferably 10-20 weight-% and most preferably 12-28 weight-% thymol, based on the total weight of the composition based on the total weight of the mixture. In yet another embodiment, the mixture of the invention is a combination of these two embodiments.

Preferably, the mixture of the invention comprises 0.1-20 weight-%, preferably 1-15 weight-%, more preferably 1-10 weight-% and most preferably 1-8 weight-% of at least one terpene, based on the total weight of the mixture. Thereby, said at least one terpene is preferably liquid at room temperature. In the context of the present invention, eugenol is a terpene that is liquid at room temperature. At room temperature, eugenol is an oil. Thus, one embodiment of the invention relates to a mixture comprising preferably fully hydrogenated soybean oil, thymol and eugenol, wherein the weight ratio between hydrogenated soybean oil and thymol is from 10:1 to 1:1, preferably from 8:1 to 2:1, more preferably from 7:1 to 3:1 and most preferably from 6:1 to 5:1, and wherein the mixture comprises 5-30 weight-% of thymol, preferably 10-20 weight-% and most preferably 12-28 weight-% thymol, based on the total weight of the mixture, and wherein mixture further comprises 0.1-20 weight-%, preferably 1-15 weight-%, more preferably 1-10 weight-% and most preferably 1-8 weight-% eugenol, based on the total weight of the mixture. Mixtures comprising a combination of thymol and eugenol are particularly effective to combat E. coli K88+.

Animals' performance and health is even more improved if the mixture of the invention further comprises at least one alkaloid. The preferred alkaloid is piperine. Preferably, the mixture of the invention further comprises 0.1-15 weight-%, preferably 0.1-10 weight-%, more preferably 2-10 weight-% and most preferably 5-9 weight-% piperine, based on the total weight of the mixture. Thus, a preferred mixture comprises:
hydrogenated soybean oil,
5-30 weight-%, preferably 10-20 weight-% and most preferably 12-28 weight-% thymol, based on the total weight of the mixture,
0.1-20 weight-%, preferably 1-15 weight-%, more preferably 1-10 weight-% and most preferably 1-8 weight-% of at least one terpene, based on the total weight of the mixture, wherein said at least one terpene is preferably liquid at room temperature, and
optionally at least one alkaloid being preferably piperine,

wherein the weight ratio between hydrogenated soybean oil and thymol is preferably from 10:1 to 1:1, preferably from 8:1 to 2:1, more preferably from 7:1 to 3:1 and most preferably from 6:1 to 5:1, and

wherein said hydrogenated soybean oil is preferably fully hydrogenated soybean oil, and

wherein said at least one terpene is preferably eugenol, and

wherein the mixture further comprises preferably 0.1-15 weight-%, more preferably 0.1-10 weight-%, even more preferably 2-10 weight-% and most preferably 5-9 weight-% piperine, based on the total weight of the mixture.

Typically, the mixture of the invention is shaped as particles. Depending on the chosen method for forming particles, one or more auxiliary compounds may be added to the mixture of the invention. In one embodiment, the mixture of the invention further comprises at least one auxiliary compound, wherein said at least one auxiliary compound is preferably silicic acid, calcium carbonate, stearic acid, glycine and/or starch. These preferred auxiliary compounds are non-toxic and fulfil the respective regulatory requirements. In a preferred embodiment, the mixture of the invention further comprises silicic acid, calcium carbonate, stearic acid, glycine and starch. Thus, one embodiment of the invention relates to a mixture comprising fully hydrogenated soybean oil, thymol and eugenol, wherein the weight ratio between hydrogenated soybean oil and thymol is from 10:1 to 1:1, preferably from 8:1 to 2:1, more preferably from 7:1 to 3:1 and most preferably from 6:1 to 5:1, and wherein the mixture comprises 5-30 weight-% of thymol, preferably 10-20 weight-% and most preferably 12-28 weight-% thymol, based on the total weight of the mixture, and wherein mixture of the invention further comprises 0.1-20 weight-%, preferably 1-15 weight-%, more preferably 1-10 weight-% and most preferably 1-8 weight-% eugenol, based on the total weight of the mixture, and wherein the mixture further comprises at least one auxiliary compound, and wherein said at least one auxiliary compound is preferably silicic acid, calcium carbonate, stearic acid, glycine and/or starch.

In the most preferred embodiment, the mixture of the invention comprises or consists of:
fully hydrogenated soybean oil,
12-28 weight-% thymol, based on the total weight of the mixture,
1-8 weight-% eugenol, based on the total weight of the mixture,
5-9 weight-% piperine, based on the total weight of the mixture, and
at least one auxiliary compound

wherein the weight ratio between fully hydrogenated soybean oil and thymol is from 6:1 to 5:1, and wherein said at least one auxiliary compound is preferably silicic acid, calcium carbonate, stearic acid, glycine and/or starch.

Particles of the Invention

Preferably, the mixture of the invention is shaped as particles. Therefore, the particles of the invention comprise or consist of the mixture of the invention. The flowable powder of the invention comprises or consists of the particles of the invention.

The preferred average particle size D (v,0.5) of the particles of the invention depends on the animal to be fed: premixes for larger animals (such as pigs) may contain larger particles than premixes for smaller animals (such as chicken). Typically, the particles of the invention have an average particle size D (v,0.5) from 0.2 mm to 10 mm, preferably from 0.2 mm to 8mm, more preferably from 0.5 mm to 5 mm and most preferably from 0.5 mm to 3 mm, measured by Laser Diffraction; Malvern Mastersizer 2000, MIE volume distribution.

The particles of the invention may be obtained by any suitable method.

Preferably, the particles of the invention are obtainable by a method comprising the steps:
i. providing a mixture that comprises molten hydrogenated soybean oil thymol, at least one auxiliary compound and optionally at least one liquid terpene;
ii. cooling the mixture provided in step i) by spraying said mixture into a cooling medium, wherein the weight ratio between hydrogenated soybean oil and thymol is from 10:1 to 1:1, and/or wherein the mixture comprises 5-30 weight-% of thymol, based on the total weight of the mixture, and wherein said at least one auxiliary compound is preferably silicic acid, calcium carbonate, stearic acid, glycine and/or starch, and wherein hydrogenated soybean oil is preferably fully hydrogenated soybean oil.

Also preferably, the particles of the invention are obtainable by a method comprising the steps:
i. providing a mixture that comprises thymol, eugenol, at least one auxiliary compound and molten hydrogenated soybean oil;
ii. cooling the mixture provided in step i) by spraying said mixture into a cooling medium,

wherein the weight ratio between hydrogenated soybean oil and thymol is from 10:1 to 1:1, and/or wherein the mixture comprises 5-30 weight-% of thymol, based on the total weight of the mixture, and wherein the mixture comprises 0.1-20 weight-%, preferably 1-15 weight-%, more preferably 1-10 weight-% and most preferably 1-8 weight-% of eugenol, based on the total weight of the mixture, and wherein said at least one auxiliary compound is preferably silicic acid, calcium carbonate, stearic acid, glycine and/or starch, and wherein hydrogenated soybean oil is preferably fully hydrogenated soybean oil.

Premix of the Invention

The premix of the invention comprises particles of the invention, whereas particles of the invention comprise or consist of the mixture of the invention. Preferably, one kilogram of said premix comprises 0.1 g to 1 g of the mixture of the invention or 0.1 g to 1 g of the particles of the invention. Premixes comprising the particles of the invention hardly de-mix, i.e. they have a good blend uniformity.

A preferred embodiment of the invention relates to a premix that comprises particles, wherein said particles are obtainable by a method comprising the steps:
i. providing a mixture that comprises molten hydrogenated soybean oil thymol, at least one auxiliary compound and optionally at least one liquid terpene;
ii. cooling the mixture provided in step i) by spraying said mixture into a cooling medium.

wherein the weight ratio between hydrogenated soybean oil and thymol is from 10:1 to 1:1, and/or wherein the mixture comprises 5-30 weight-% of thymol, based on the total weight of the mixture, and wherein said at least one auxiliary compound is preferably silicic acid, calcium carbonate, stearic acid, glycine and/or starch, and wherein hydrogenated soybean oil is preferably fully hydrogenated soybean oil, and wherein one kilogram of the premix comprises preferably 0.1 g to 10 g of said particles.

An also preferred embodiment of the invention relates to a premix that comprises per kg premix 0.1 g to 10 g of a mixture, wherein said mixture comprises hydrogenated soybean oil and thymol, and wherein the weight ratio between hydrogenated soybean oil and thymol is from 10:1 to 1:1, and/or wherein the mixture comprises 5-30 weight-% of thymol, based on the total weight of the mixture.

Typically, the premix of the invention is added to food or feed. Thus, the present invention also relates to food or feed comprising the premix of the invention, the mixture of the invention and/or the particles of the invention.

Preferred amounts are indicated in below table:

| | content of the mixture of the | | content of the particles of | |
|---|---|---|---|---|
| | invention . . . | | the invention . . . | |
| | . . . per kg | . . . per ton | . . . per kg | . . . per ton |
| | premix | feed | premix | feed |
| preferred | 0.1 g/kg to | 1 g/t to | 0.1 g/kg to 10 | 1 g/t to |
| range | 10 g/kg | 100 g/t | g/kg | 100 g/t |
| more preferred | 2 g/kg to | 20 g/t to | 2 g/kg to | 20 g/t to |
| range | 8 g/kg | 80 g/t | 8 g/kg | 80 g/t |
| most preferred | 3 g/kg to | 30 g/t to | 3 g/kg to | 30 g/t to |
| range | 6 g/kg | 60 g/t | 6 g/kg | 60 g/t |

Preferably, 1 ton of feed comprises 1 g to 100 g of a mixture, wherein said mixture comprised fully hydrogenated soybean oil, thymol and optionally eugenol, wherein the weight ratio between hydrogenated soybean oil and thymol is from 10:1 to 1:1, preferably from 8:1 to 2:1, more preferably from 7:1 to 3:1 and most preferably from 6:1 to 5:1. Also preferably, 1 ton of feed comprises 1 g to 100 g particles, wherein said particles comprise hydrogenated soybean oil, thymol and optionally eugenol, and wherein the weight ratio between hydrogenated soybean oil and thymol is from 10:1 to 1:1, and wherein the particles comprise 5-30 weight-% of thymol, based on the total weight of the particles.

The present invention also relates to feed comprising particles, wherein said particles are obtainable by a method comprising the steps:
i. providing a mixture that comprises molten hydrogenated soybean oil thymol, at least one auxiliary compound and optionally at least one liquid terpene;
ii. cooling the mixture provided in step i) by spraying said mixture into a cooling medium,

wherein the weight ratio between hydrogenated soybean oil and thymol is from 10:1 to 1:1, and/or wherein the mixture comprises 5-30 weight-% of thymol, based on the total weight of the mixture, and wherein said at least one auxiliary compound is preferably silicic acid, calcium carbonate, stearic acid, glycine and/or starch, and wherein hydrogenated soybean oil is preferably fully hydrogenated soybean oil.

Methods of the Invention

The mixture of the invention is preferably obtained by a method comprising the steps:
1. melting of hydrogenated soybean oil
2. addition of thymol and optionally addition of at least one liquid terpene to the melt obtained in step 1) while stirring,

such that the weight ratio between hydrogenated soybean oil and thymol the melt obtained in step 2) is from 10:1 to 1:1, and wherein the melt obtained in step 2) comprises 5-30 weight-% of thymol, based on the total weight of the melt, wherein said at least one terpene is liquid at room temperature.

More preferably, the mixture of the invention is obtained by a method comprising the steps:
1. melting of hydrogenated soybean oil
2. addition of thymol and eugenol to the melt obtained in step 1) while stirring

such that the weight ratio between hydrogenated soybean oil and thymol the melt obtained in step 2) is from 10:1 to 1:1, and wherein the melt obtained in step 2) comprises 5-30 weight-% of thymol, and wherein the melt obtained in step 2) further comprises 0.1-20 weight-%, preferably 1-15 weight-%, more preferably 1-10 weight-% and most preferably 1-8 weight-% eugenol, based on the total weight of the melt.

The present invention also relates to a method to shape the mixture of the invention as particles. Preferably, said method is preferably spray chilling, also referred to as prilling.

One embodiment of the invention relates to a method of manufacturing particles comprising hydrogenated soybean oil and thymol, said method comprising the steps:
i. providing the mixture of the invention, wherein the mixture has a temperature of at least 65° C.;
ii. cooling the mixture provided in step i) by spraying said mixture into a cooling medium

wherein the mixture provided in step i) has a temperature of preferably at least 67° C. or at least 70° C., more preferably at least 72° C., even more preferably at least 75° C. and most preferably at least 80° C.

Preferably, the method of manufacturing the particles of the invention comprises the steps:
i. providing the mixture that comprises thymol, optionally eugenol, optionally at least one auxiliary compound and hydrogenated soybean oil,
ii. heating the mixture provided in step i) to a temperature of at least 65° C.;
iii. cooling the mixture provided in step ii) by spraying said mixture into a cooling medium

wherein the mixture provided in step ii) is preferably heated to a temperature of at least 67° C. or at least 70° C. or to at least 72° C., even more preferably at least 75° C. and most preferably at least 80° C., and wherein the weight ratio between hydrogenated soybean oil and thymol in the mixture provided in step i) is from 10:1 to 1:1, and wherein the mixture comprises 5-30 weight-% of thymol, based on the total weight of the mixture, and wherein the mixture provided in step i) comprises preferably 0.1-20 weight-%, more preferably 1-15 weight-%, even more preferably 1-10 weight-% and most preferably 1-8 weight-% eugenol, based on the total weight of the mixture.

Use of the Invention

The present invention also relates to the use of hydrogenated soybean oil for manufacturing a particulate feed additive that is resistant to heat induced caking, wherein hydrogenated soybean oil is preferably fully hydrogenated soybean oil.

A preferred embodiment of the invention relates to the use of hydrogenated soybean oil for manufacturing a particulate feed additive that is resistant to heat induced caking, wherein hydrogenated soybean oil is preferably fully hydrogenated soybean oil and wherein said particulate feed additive comprises thymol and optionally at least one terpene that is liquid at room temperature, and wherein the weight ratio between fully hydrogenated soybean oil and thymol is from 10:1 to 1:1, and/or wherein the weight ratio between thymol and the at least one terpene is from 100:1 to 1.5:1.

Furthermore, the present invention also relates to a mixture comprising hydrogenated soybean oil, thymol and eugenol for use in the treatment of gastrointestinal disorders. A preferred embodiment relates to a mixture comprising hydrogenated soybean oil, thymol and eugenol for use in the treatment of gastrointestinal disorders caused by Escherichia coli K88+.

The present invention also relates to particles comprising or consisting of a mixture, said mixture comprising hydrogenated soybean oil, thymol and eugenol for use in the treatment of gastrointestinal disorders. A preferred embodiment relates to particles comprising or consisting of a mixture, said mixture comprising hydrogenated soybean oil, thymol and eugenol for use in the treatment of gastrointestinal disorders caused by Escherichia coli K88+.

Furthermore, the present invention also relates to a feed additive comprising hydrogenated soybean oil, thymol and eugenol for use in the treatment of gastrointestinal disorders. A preferred embodiment relates to a feed additive comprising hydrogenated soybean oil, thymol and eugenol for use in the treatment of gastrointestinal disorders caused by Escherichia coli K88+. In a preferred embodiment, said feed additive is the premix of the invention.

### FIGURES

FIG. 1a shows the Differential Scanning calorimetry (DSC) thermogram of hydrogenated palm oil (HPO). DSC is a thermoanalytical technique in which the difference in the amount of energy required to increase the temperature of a sample respective to its environment is measured as a function of temperature. On the x-axis, the temperature is shown in ° C. On the y-axis, energy flow is shown (normalized, i.e. Watt/g of the composition). Negative energy flow indicates endothermic processes (e.g. melting). In FIGS. 1 a to 3, minima are endothermic peaks. Thus, the DSC thermogram in FIG. 1a shows two endothermic peaks. Positive energy flow corresponds to exothermic processes. In the FIGS. 1 a to 3, maxima are exothermic peaks. Thus, the DSC thermogram in FIG. 1a shows one exothermic peak.

FIG. 1b shows the DSC thermogram of fully hydrogenated soybean oil (FHSO). The DSC thermogram of FIG. 1b also shows two endothermic peaks. However, in comparison to the DSC thermogram shown in FIG. 1 a corresponding to the thermogram of fully hydrogenated palm oil (HPO), the two endothermic peaks of FHSO appear at higher temperatures.

In FIG. 2, DSC thermograms of the samples of comparative Example 2 are shown: sample 1a (HPO), sample 2 (ThyHPO) and sample 3 (EugThyHPO). ThyHPO is a mixture of thymol (Thy) and hydrogenated palm oil (HPO). FIG. 2 shows that ThyHPO melts at a lower temperature than HPO as such. EugThyHPO is a mixture of eugenol (Eug), thymol (Thy) and hydrogenated palm oil (HPO). FIG. 2 shows that EugThyHPO melts at an even lower temperature. The effects shown in FIG. 2 have some similarities with a phenomenon known as freezing-point depression.

In FIG. 3, DSC thermograms of the samples of Example 3 are shown: sample 1 b (FHSO), sample 4 (ThyFHSO) and sample 5 (EugThyFHSO). ThyFHSO is a mixture of thymol (Thy) and fully hydrogenated soybean oil (FHSO). FIG. 3 shows that the melting temperature of ThyFHSO is as high as the melting temperature of FHSO as such. This is surprising: when mixing thymol with FHSO, the freezing-point depression phenomenon does not show. EugThyFHSO is a mixture of eugenol (Eug), thymol (Thy) and fully hydrogenated soybean oil (FHSO). FIG. 3 shows that not even the addition of an oily liquid (eugenol) lowers the melting temperature of FHSO as such. Therefore, FHSO can be used for manufacturing a particulate feed additive that is resistant to heat induced caking.

### EXAMPLES

### Example 1

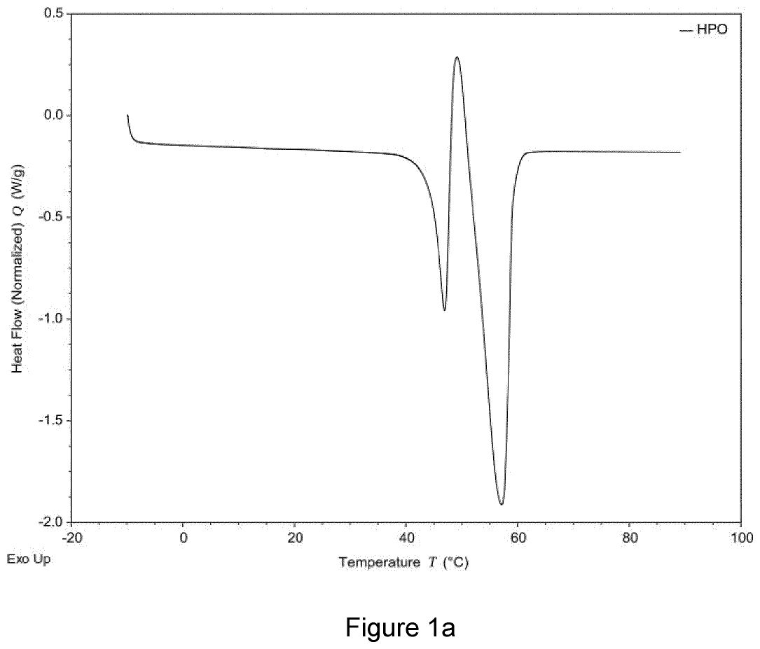

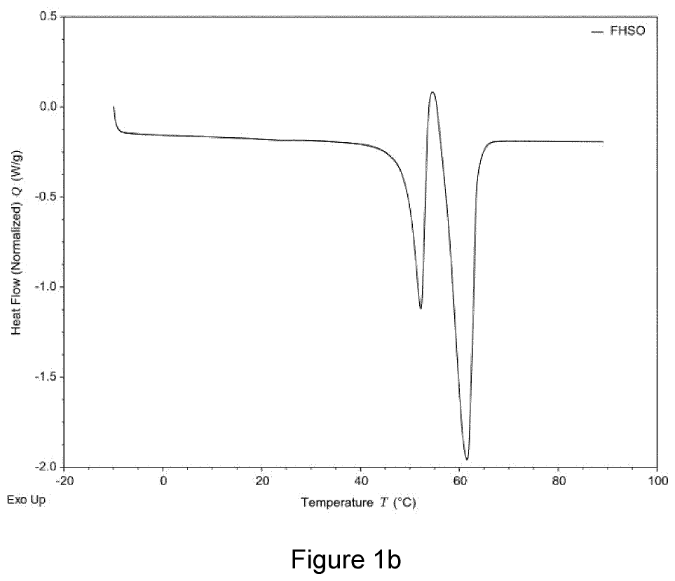

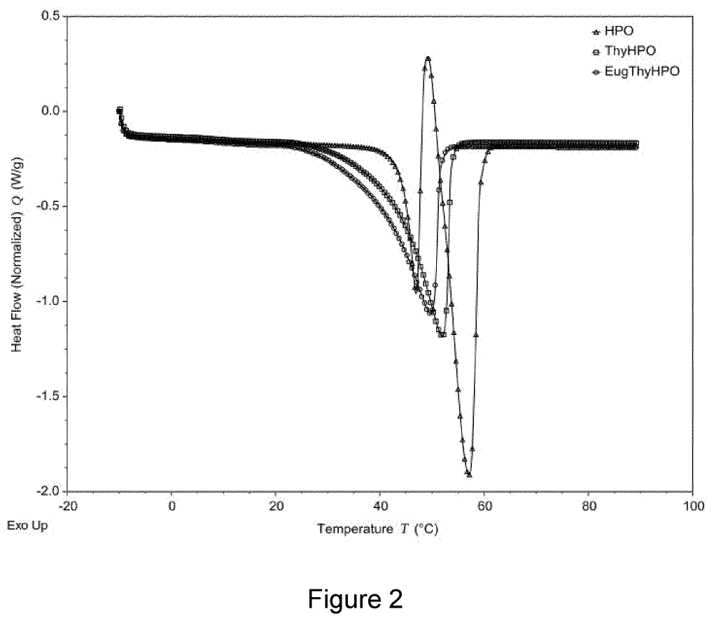

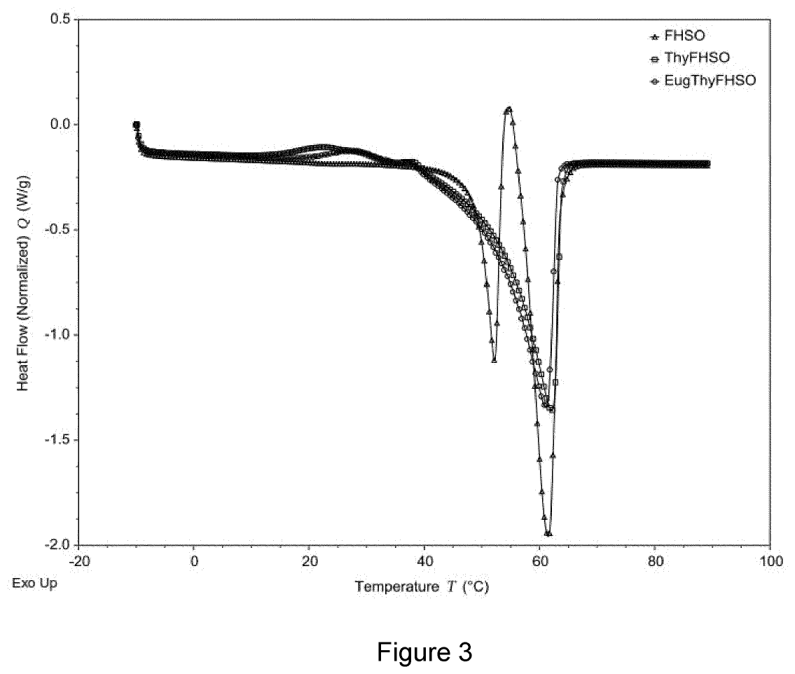

In Example 1, the melting points of hydrogenated palm oil (HPO) and fully hydrogenated soybean oil (FHSO) were determined by Differential Scanning calorimetry using a Discovery DSC (TA Instruments, Waters GmbH, Eschborn). Determination of melting points in Example 1 is from the 2^{nd} heating cycle at 5° C. per minute from −10° C. to 90° C. Melting point was determined by the peak temperature Tₚ (cf. G. Höhne, H. Cammenga, W. Eysel, E. Gmelin and W. Hemminger, “The Temperature Calibration of Scanning calorimeters,” Thermochimica Acta, vol. 160, pp. 1-12, 1990). The results are shown in FIG. 1a (HPO) and FIG. 1b (FHSO).

Both samples, HPO (sample 1a) and FHSO (sample 1b), display two melting peaks corresponding to different fatty acid compositions and chain length within the triacylglyceride (TAG). Possibly, the first melting peak relates to C16:0 chains within the TAG and alpha crystals while the second melting peak might relate to C18:0 chains within the TAG and beta crystals. Unless the second melting peak has been reached, the corresponding product (HPO or FHSO) is not fully liquid. The exothermic peak separating the two endothermic peaks may relate to melt-mediated transformation of crystals.

The analysis of the data shown in FIGS. 1a and 1b is given in below

TABLE 1
Table 1

| Sample | Endothermic peak (° C.) |
|---|---|
| HPO | 46.9 (C16:0) 57.0 (C18:0) |
| FHSO | 52.9 (C16:0) 61.5 (C18:0) |

FHSO shows slightly higher melting temperatures than HPO. This might be related to differences between the respective fatty acid compositions: FHSO comprises less C16:0 triacylglycerides than HPO but more C18:0 triacylglycerides than HPO (R. Tieko Nassu and L. A. Guaraldo Goncalves, “Determination of melting point of vegetable oils and fats by differential scanning calorimetry (DSC) technique,” Grasas y aceotes, pp. 16-22, 1992 and I. V. J. R. G. L. R. M. Teles dos Santos, “Thermal properties of palm stearin, canola oil and fully hydrogenated soybean oil blends: Coupling experiments and modeling,” Journal of Food Engineering, vol. 185, pp. 17-25, 2016).

### Comparative Example 2

In Example 2, two samples were prepared by the following process:
1. Melting of hydrogenated palm oil (HPO) in a 75° C. water bath.
2. Addition of thymol (sample 2), or thymol and eugenol (sample 3), one after the other while stirring at 200 rpm.
3. Speed up of stirring (500 rpm) and mix for 3 min.
4. Cool down slowly at room temperature.

During steps 2-3 of the preparation process, temperature was set to 75° C. No separation of oils was observed during cooling step 4 (i.e. the surface remained “dry”). After cooling, the composition was grounded, and samples were taken for DSC analysis. All ingredients are commercially available. Thymol (purity: 99%) was purchased at VWR Chemicals, eugenol (purity: 99%) at Merk KGaA.

The composition of samples 2 and 3 as prepared in Example 2 is shown in below TABLE 2. In comparison, the composition of sample 1a of Example 1 is also shown in Table 2.

TABLE 2

| | sample 1a | sample 2 | sample 3 |
|---|---|---|---|
| | HPO | ThyHPO | EugThyHPO |
| hydrogenated palm oil (HPO) | 5 g | 17.1 g | 15.59 g |
| thymol | 0 g | 2.9 g | 2.91 g |
| eugenol | 0 g | 0 g | 1.5 g |
| total weight | 5 g | 20 g | 20 g |
| weight ratio HPO:thymol | n/a | 5.9:1 | 5.4:1 |

For each of the samples, a melting curve was measured by Differential Scanning calorimetry, using a Discovery DSC (TA Instruments, Waters GmbH, Eschborn). Melting points were determined as described in Example 1. The obtained the DSC thermograms are shown in FIG. 2.

FIG. 2 shows that the addition of thymol to HPO merges the peaks of HPO into one endothermic peak. Thereby, the merged peak appears at lower temperature (51.9° C.) than the 2^{nd} endothermic peak of pure HPO (57.0° C.). 51.9° C. is a temperature that may be reach in a closed truck standing in the sun during summer. Therefore, the formation of lumps (caking) during transportation cannot be excluded when using HPO for manufacturing a particulate feed additive. The risk of heat induced caking becomes ever higher when both, thymol and eugenol are admixed to HPO (sample 3): the merged peak of such mixture appears at an even lower temperature (49.8° C.).

### Example 3

In Example 3, the approach of Example 2 was repeated. In Example 3, however, fully hydrogenated soybean oil (FHSO) was used instead of HPO.

The composition of samples 4 and 5 as prepared in Example 3 is shown in below TABLE 3. In comparison, the composition of sample 1b of Example 1 is also shown in Table 3.

TABLE 3

| | sample 1b | sample 4 | sample 5 |
|---|---|---|---|
| | FHSO | ThyFHSO | EugThyFHSO |
| fully hydrogenated soybean oil | 5 g | 17.1 g | 15.59 g |
| (FHSO) | | | |
| thymol | 0 g | 2.91 g | 2.91 g |
| eugenol | 0 g | 0 g | 1.51 g |
| total weight | 5 g | 20.01 g | 20.01 g |
| weight ratio | n/a | 5.9:1 | 5.4:1 |
| FHSO:thymol | | | |

For each of the samples, a melting curve was measured by Differential Scanning Calorimetry as described in Example 2. The obtained the DSC thermograms are shown in FIG. 3.

FIG. 3 shows that the addition of thymol to FHSO merges the peaks of pure FHSO into an endothermic peak. This is similar to FIG. 2. However, apart from this similarity, there are major differences.

When adding thymol to FHSO, an exothermic peak is observed from 12° C. to about 33° C. This exothermic peak appears regardless whether or not eugenol has also been added. This possibly indicates a crystal reconfiguration which does not take place in case of HPO (cf. FIG. 2).

More importantly, and very surprising, the risk of heat induced caking is not increased or is even decreased when thymol (sample 4) or thymol and eugenol (sample 5) are admixed to FHSO: the endothermic peaks of the respective mixtures appear at about the same temperature as the 2^{nd} endothermic peak of FHSO (61.5° C.) as such. An overview of the results of Examples 2 and 3 is given in below TABLE 4.

TABLE 4

| | 1^{st} | 2^{nd} | Δ to respective 2^{nd} |
|---|---|---|---|
| | endothermic | endothermic | endothermic peak |
| Sample | peak (° C.) | peak (° C.) | (° C.) |
| FHSO | 52.9 | 61.5 | |
| ThyFHSO | 62.1 | | 0.6 |
| EugThyFHSO | 61.8 | | 0.3 |
| HPO | 46.9 | 57.0 | |
| ThyHPO | 51.9 | | −5.1 |
| EugThyHPO | 49.8 | | −7.2 |

In case of two endothermic peaks, a fully melted composition is not obtained until the temperature of the 2^{nd} peak has been reached. Therefore, the melting point of ThyFHSO (62.1° C.) is about 10° C. higher than the melting point of ThyHPO (51.9° C.) whereas the melting point of FHSO (61.5° C.) is only about 4.5° C. higher than the melting point of HPO (57° C.). This is surprising.

This surprising effect is even more pronounced if both, thymol and eugenol are added: the melting point of EugThyFHSO (61.8° C.) is about 12° C. higher than the melting point of EugThyHPO (49.8° C.) whereas the melting point of FHSO (61.5° C.) is only about 4.5° C. higher than the melting point of HPO (57° C.).

The likelihood that a temperature of 61.8° C. (cf. EugThyFHSO) is reached during transportation is lower than the likelihood that a temperature of 49.8° C. (cf. EugThyHPO) is reached in a closed truck during summer. Therefore, heat induced caking can be prevented or at least reduced when using FHSO instead of HPO for manufacturing a particulate feed additive.

### Example 4

Particles comprising the mixture of the invention were manufactured as follows:

Molten fully hydrogenated soybean oil was mixed with thymol, eugenol and selected auxiliary compounds. To obtain particles, the hot, liquid mixture was cooled by spraying (spray chilling). Organoleptic inspection of the obtained particles confirmed a reduced smell.

The thus obtained particles were a flowable powder. The powder was then stored in a climatic chamber for 3 days in conditions of 52.5° C. and relative humidity (rH) of 60%. After the elapsed period, the powder was still flowable. No lumps could be observed. Example 4 shows that particles of the invention are resistant to heat induced caking.

The powder of Example 5 can be used to prepare a premix. Feed comprising the thus prepared premix may then be fed to broilers or other animals.

### Comparative Example 5

In Example 5, particles were manufactured as described in Example 4. However, instead of fully hydrogenated soybean oil, hydrogenated palm oil was used in Example 5. The thus manufactured particles were a flowable powder. The powder of Example 5 was then also stored in a climatic chamber for 3 days in conditions of 52.5° C. and rH of 60%, similar to Example 4. However, after the elapsed period, the powder of Example 5 was no longer flowable. Instead, the previously flowable powder has melted together and has become one large, solid object. Thus, the particles of Example 5 are prone to heat induced caking.

After having been exposed to a temperature of 52.5° C., the powder prepared in Example 5 could no longer be used to prepare a premix. Large, solid agglomerates are useless and thus, must be discharged.

### Example 6

On a sunny day in the late afternoon, the temperature was measured in a truck on a parking lot in Italy. Air-conditioning and engine had been switched off. The loading area of the truck was covered, and all windows were closed. When the temperature was measured, the truck had been on the parking lot for about 8 hours.

A temperature of about 49° C. was measured inside the truck. In the previous examples, the melting temperature of EugThyFHSO has been determined as 61.8° C. and would therefore resist the temperature measured in the truck of Example 6.

### Example 7

In Example 7, antimicrobial activity of thymol, eugenol and a combination of thymol and eugenol was evaluated against pathogenic bacteria. Thymol and eugenol were purchased from Sigma-Aldrich (St. Louis, MO, USA). They were stored at 4° C. before use.

Bacterial strains: Three strains of pathogenic bacterial, E. coli K88+, S. choleraesuis and Cl. perfringens obtained from China Veterinary Culture Collection Center were used to determine the antimicrobial activity of thymol, eugenol and/or thymol. E. coli K88+and S. choleraesuis were aerobic and isolated from the gastrointestinal tract of swine, Cl. perfringens was anerobic and isolated from poultry. The three strains were kept in broth with 25% glycerol at −80° C.

Antimicrobial activity of thymol and eugenol: The minimum inhibitory concentration (MIC) values of thymol and eugenol, respectively, were determined using two-fold broth dilution method. The compounds were dissolved in analytical grade ethanol and serially diluted to yield various concentrations, typically in the range of 6.03-368.17 mmol/L. The bacterial suspensions were measured at OD600ₙₘ and standardized to a concentration of 10⁵-10⁶ CFU/mL with the culture broth. Aliquots of 150 μL of each bacterial broth were pipetted into the wells of a 100-well microtiter plate and 3.14 μL of eugenol or thymol concentration was, respectively, added into the wells followed by adding 150 pl of bacterial suspensions to give a final ethanol concentration at 1%. A blank control well contained bacterial broth and suspensions, and 3.04 pL of ethanol instead of eugenol or thymol. The plate was incubated with shaking at 37° C. with the Bioscreen C system (Labsystem, Helsinki, Finland). The growth of bacterial was measured by reading the OD600nm at 30 min intervals for 24 hr and kinetic curves were analysed. The MIC was considered as the lowest concentration showing no growth of bacterial. All the tests were carried out in triplicate, and mean value was calculated. All the procedures with Cl. perfringens were carried out under anaerobic conditions.

Antimicrobial activity combination: thymol and eugenol were assessed in combination to determine their activity against E. coli K88+as described previously. The kinetic curves were analysed by Origin 2017 calculating lag phase (A), which was selected as criteria for comparison of antimicrobial efficacy.

The results of Example 7 are shown in TABLES 5 and 6.

For Escherichia coli K88+and Salmonella choleraesuis the ranking of antimicrobial performance based on MIC values was: thymol >eugenol. The particles of the present invention comprise thymol and show therefore excellent antimicrobial performance.

The duration of the lag phase (A) is criteria for antimicrobial efficacy. During lag phase, the cells adapt to a new environment. Lag phase is then followed by the log phase, in which population grows in a logarithmic fashion. The grown cells are harmful, and thus, the longer the lag phase, the better. The data in Table 6 shows that combination of thymol and eugenol results in a longer lag phase than the same amount of thymol alone or eugenol alone. A preferred embodiment of the invention relates to a mixture comprising both, thymol and eugenol. The product of said preferred embodiment is particularly effective to combat E. coli K88+.

TABLE 5
Minimum inhibitory concentration (MIC) values of
thymol and eugenol against Escheria coli K88⁺,
Salmonella cholerasuis and Clostridium perfingens

| | MIC values (mmol/L) | | |
|---|---|---|---|
| | Escheria | Salmonella | Clostrisium |
| compound | coli K88⁺ | choleraesius | perfringens |
| Thymol | 1.5 | 1 | 1 |
| Eugenol | 2.5 | 2.5 | 4 |

The Lag phase (λ) of thymol and eugenol
individually or in combination against
Escheria coli K88⁺¹

| Essential | Dosage, | | Dosage, | |
|---|---|---|---|---|
| oil | mmol/L | λ | mmol/L | λ |
| Individually | | | | |
| Thymol | 0.5 | 1.65 | 0.25 | 1.66 |
| Eugenol | 0.5 | 1.91 | 0.25 | 1.77 |
| Combination | | | | |
| Thymol + Eugenol | 0.25 + 0.25 | 1.99 | | |

1. Mixture comprising hydrogenated soybean oil and thymol, wherein the weight ratio between hydrogenated soybean oil and thymol is from 10:1 to 1:1, and wherein the mixture comprises 5-30 weight-% of thymol, based on the total weight of the mixture.

2. Mixture according to claim 1, wherein said mixture further comprises 0.1 20 weight-%, preferably 1-15 weight-%, more preferably 1-10 weight-% and most preferably 1-8 weight-% of at least one terpene, based on the total weight of the mixture, and wherein said at least one terpene is liquid at room temperature.

3. Mixture according to claim 1, wherein said mixture comprises:
fully hydrogenated soybean oil,
5-30 weight-%, preferably 10-20 weight-% and most preferably 12 28 weight-% thymol, based on the total weight of the mixture,
0.1-20 weight-%, preferably 1-15 weight-%, more preferably 1-10 weight-% and most preferably 1-8 weight-% eugenol, based on the total weight of the mixture and
optionally at least one alkaloid being preferably piperine,
wherein the weight ratio between fully hydrogenated soybean oil and thymol is from 10:1 to 1:1, preferably from 8:1 to 2:1, more preferably from 7:1 to 3:1 and most preferably from 6:1 to 5:1.

4. Mixture according to claim 1, wherein said mixture further comprises at least one auxiliary compound, and wherein said at least one auxiliary compound is preferably silicic acid, calcium carbonate, stearic acid, glycine and/or starch.

5. Particles comprising or consisting of the mixture according to claim 1.

6. Particles according to claim 5, wherein said particles are obtainable by a method comprising the steps:
i. providing a mixture that comprises thymol, optionally eugenol, at least one auxiliary compound and molten hydrogenated soybean oil;
ii. cooling the mixture provided in step i) by spraying said mixture into a cooling medium.

7. Premix comprising the mixture according to claim 1.

8. Premix according to claim 7, wherein one kilogram of said premix comprises 0.1 g to 10 g.

9. Food or feed, comprising the mixture according to claim 1. cm 10. Feed according to claim 9, wherein one ton of said feed comprises 1 g to 100 g of the mixture.

11. Method of manufacturing particles comprising hydrogenated soybean oil and thymol, said method comprising the steps:
i. providing the mixture according to claim 1, wherein the mixture has a temperature of at least 65° C.;
ii. cooling the mixture provided in step i) by spraying said mixture into a cooling medium.

12. Method according to claim 11, wherein the mixture provided in step i) has a temperature of at least 67° C., preferably at least 70° C., more preferably at least 72° C., even more preferably at least 75° C. and most preferably at least 80° C.

13. Use of fully hydrogenated soybean oil for manufacturing a particulate feed additive that is resistant to heat induced caking.

14. Use according to claim 13, wherein said particulate feed additive comprises thymol and optionally at least one terpene that is liquid at room temperature.

15. Use according to claim 14, wherein the weight ratio between fully hydrogenated soybean oil and thymol is from 10:1 to 1:1, and/or wherein the weight ratio between thymol and the at least one terpene is from 100:1 to 1.5:1.
